(19) United States
(12) Patent Application Publication
(10) Pub. No.: US 2020/0090543 A1
(43) Pub. Date: Mar. 19, 2020

(54) Process for translating real-life achivement and aptitude scores performed and assessed exogenously from gaming and simulation environments into game and simulator objects and object enhancements

(71) Applicant: Peter Jeffery McDaniels, Aberdeen, WA (US)

(72) Inventor: Peter Jeffery McDaniels, Aberdeen, WA (US)

(21) Appl. No.: 16/350,031

(22) Filed: Sep. 15, 2018

(51) Int. Cl. G09B 19/00

(52) U.S. Cl. CPC G09B 19/00

(57) ABSTRACT

A process that translates scores, from real-life activities, achieved exogenously from games and simulations the scores enhance. Game and simulation objects can be developed without the burden of including real-life activities, such as academics, sports, recreation, and performance, inside of the games and simulations themselves. The process harnesses behaviors to compel humans to participate in real-life activities by making game and simulation objects reliant upon the scores which the humans achieve. The process allows the humans to stage, display, and use the scores in the form of game and simulation objects for self and others to see. Activity score translation is achieved by manual. and or automated processes, exemplified in embodiments herein, at a translation intersection point where the scores of real-life activities are introduced into games and simulations and are spent on game and simulation objects, and object attributes and enhancements.

Aka: Activity Score Translation (AST) Process

Aka: MINDSTAGE—A PLATFORM FOR YOUR BRAIN™ (Currently, a provisional trademark application has been submitted to the USPTO).

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

Background—“Games have been entertaining and teaching humans for thousands of years. It is hardly a trend! People are finally connecting the dots from play to learning [ . . . ] Ancient games were used to reinforce belief systems, strategize (sic), and apply a practical use of mathematics.”

From the book “Gamify Your Classroom” by Mathew Farber, published by Peter Lang (2015) ISBN 978-1-4331-2670-3 (paperback) pg. 10-11 (GYC).

In GYC, Farber points to several games to include:
1. Mancala—played in ancient Greece using sheep knuckles as dice with the objective of capturing the opponent's game. pieces;
2. Senet—one of the earliest games on record discovered within the tombs of the Egyptian pharaohs with the presumed purpose of reinforcing religious beliefs and skills;
3. Snakes and Ladders—originated in India, and it reinforced tenets of Jainism such as karma; and
4. Kriegspiel—a complicated game emanating from Europe devised as an educational game to supplement military school training.

The above four games and all games, according to Farber, have one thing in common, “[A]ll games are educational. After all, you need to learn a game to master it!” (GYC pg. 2).

Today's patent application considers: pen, ink and paper games, tabletop games, video games, and simulators all for educational, entertainment, and serious purposes.

Problem—unquestionably, the collision of games and academics brings forth varying opinions of the people. I have encountered a wide spectrum of opinions between two extremes: Some people embrace the concept of educating through games while others are of the opinion that games and education should be kept separate; both garners and educators share in this separation-based opinion at varying degrees. This subset of hard-core garners, and the traditional educators (which I have labelled as the “bah humbugs”) have strong arguments:

The former recognizing the fact that when academics are introduced into a gaming environment, they devalue the experience and the end-game result many garners are seeking.

The educators, of course, recognize the fundamental importance of education as a serious endeavor that has long standing traditions to support the curriculum. Common core state standards and trade and professional course work, when compounded by the need for real-life human interaction and experience, are essential for the growth of a healthy society compelled towards decency.

I have been rebuked by the hard-core garners in my neighborhood when attempting to integrate education into common role playing games. They say, “We play games to have fun,” “I go on raids to escape real-life—not to learn about biology,” and “I went to school, been there, done that!” And more insulting comments are omitted.

Likewise, while at the university, the naysayers of academia were prudent and plenty. These bah humbugs would say, “Games don't belong in school—you're here to learn.” There is a clear separation here; games were like oil—not mixing with the waters of traditional education.

In fact, Henry Jenkins, media scholar and publisher of several books including “Convergence Culture: Where Old and New Media Collide (2006)” and cofounder of MIT's “Educational Arcade” which prototypes how games could be used for learning is quoted as saying, “When I talk to teachers, the kneejerk (sic) response is that children should be doing homework and not playing games.” (GYC pg. 4).

I must admit that I too am a bah humbug; however, I also will readily admit that I am a hard core gamer. So instead of attempting to convince these two extremes to give way to its opposite (which I believe is where the industry has focused), today's patent application properly addresses the conundrum:

Why have liberal arts educators left those long standing traditions of academia, parting ways with the bah humbugs, to unsuccessfully attempt to introduce curricula into a gaming industry which people turn to in order to escape reality—not embrace it? The right solution is to change the way we think about introducing academics and real-life activities into games and artificial simulation environments at a conservative intersection that neither destroys the end-game experience or the grand traditions of clubdom, intellectualism, and performance.

The complete answer is to keep games and education or real-life activity separate while maintaining their reliance on one another to encourage play on one hand, free from the stresses of real-life, while compelling real-life activity and achievement recognition on the other.

Prior to discussing what I am currently contemplating as a first embodiment, and an alternate embodiment, I will provide the following sections:

Under the first section, I present a very serious problem I believe could be solved, in-part, using the Activity Score Translation (AST) process.

* Additional Supporting Information (A Serious Problem)

* Technical Information, Some Definitions, and Sample Activities

* Prior Surrounding Art and Some of Its Disadvantages

* Summary

* Advantages

* Drawings' figures

* Drawings' reference numbers

The next sections are as follows:

* Manual to manual AST process: first embodiment description and example

* Automated to automated AST process: an alternate embodiment description and example

* Conclusion, Ramifications, and Scope

* Claims

* Abstract

* Glossary

Additional Supporting Information—Today's patent application also addresses the increasing phenomenon of game addiction which leaves people in a similar state of ruin as alcohol, drug, and gambling addictions.

In a WebMD article, Kimberly Young, PsyD, clinical director of the Center for On-line. Addiction, says, “I've had so many parents call me over the last year or two, particularly about role-playing games online. I see it getting worse as the opportunity to game grows.” The author of the article, Sherry Rauh, continues, “But can a game truly become an addiction? Absolutely, Young tells WebMD. “It's a clinical impulse disorder,” an addiction in the same sense as compulsive gambling. [ . . . ] While most people associate addiction with substances [ . . . ] doctors recognize addictive behaviors as well.”

As shown in the article, psychiatrist Michael Brody, MD, set forth the following criteria:
1. The person needs more and more of a substance or behavior to keep him going; and
2. If the person does not get more of the substance or behavior, he becomes irritable and miserable.

Young says compulsive gaming meets these criteria, and she has seen severe withdrawal symptoms in game addicts. “They become angry, violent, or depressed. If [parents] take away the computer, their child sits in the corner and cries, refuses to eat, sleep, or do anything.”

I agree that their is a problem with game addiction; however, I disagree that the solution, as the WebMD article highlights, is to stop playing games. I believe that the addictive behavior can be harnessed.

Technical Information, Some Definitions, and Sample Activities—“activity score” means a measurement of a person's certain knowledge, skill, performance, achievement, or aptitude produced from: examinations or otherwise named test scores; times elapsed; grades; assessments; and/or proven aptitude results (any single, set, or constellation of measurable characteristics known to predispose to the learning of, proof of, reflection of, the accomplishment of learning and performing that can be construed as or said to be a “score”) designated in an alphabetic, numerical, or similar rating scheme (e.g. color or symbol) or any combination thereof derived from any source as input that is extrinsic to the:
1. Pen, ink, and paper game;
2. Tabletop game;
3. Video game; or
4. Simulator.

Hereinafter referred to as “score”; and also known as “transient-extrinsic cause” when viewed through the lens of its translation: a game or simulation.

“Translation process” means to render the score into game or simulator objects or enhancements to game and simulator objects in parallel, equal-whole, equal-analytic, comparable and/or functional equivalent, random, offset, or otherwise terms (the translated intrinsic or immanent effect) of the score's original subjective and/or objective state, status, and contributed-achieved performance or aptitude level to be made use of in the gaming or simulation environment at any time, immediately, or whenever thereafter the score is translated, or introduced from whencesoever into any gaming or simulation environments while in all cases, the activity that originates the translated intrinsic or immanent effect is performed while not playing the game or participating in the simulation.

“Maximum activity score” means the highest activity score: objectively, subjectively, perceivably (or any combination thereof) possible for any given activity.

Example #1 OBJECTIVE: A teacher passes out a math test to his or her students. The test consists of twenty (20) math problems worth five (5) points each. A score of twenty (20) is the maximum activity score.

Example #2 SUBJECTIVE: A high-diver at a swimming arena participates in a diving competition that is judged by a panel of five (5) judges. Each judge assesses one dive performed by the high-diver; consequently, each will display a score card labelled one (1) through ten (10) with ten (10) being the highest. A score of fifty (50) is the maximum activity score.

Example #3 PERCEIVED: A runner is training for an upcoming competition with a rival school. The runner's instructor wants to make sure he or she places the best runners on the team up against the rival school's team. In order to qualify, the runner must run against the clock. The instructor selects four minutes and forty-eight seconds (00:04:48) as the time to beat because it is the rival school's current record for the mile. In this case, 00:04:48 is the maximum activity score.

NOTE: Any score derived from any aptitude analysis or otherwise testing, competition or otherwise event where one person or entity is in “standing” (i.e. first, second, third . . . gold, silver, bronze . . . etc.) is distinct to example #1 above: objective.

“Activity score percentile” means the activity score is translated into a standardized percentage after being compared to its corresponding maximum activity score either prior to, during, or after the score is introduced to the game or simulation.

NOTE: I am currently contemplating for the embodiments herein to utilize a standardized percentage of one-hundred percent (100%); however, other standardized percentages can be used.

Examples from maximum activity scores #1, #2, and #3 above:

Example of example #1: OBJECTIVE: Let's say one of the students got fourteen (14) out of the twenty (20) math problems correct. That gives him or her fourteen (14) points. Because twenty (20) points is the maximum activity score, the student's activity score percentile is seventy percent (70%). Fourteen (14) is seventy percent (70%) of twenty (20).

For an extended example of the OBJECTIVE type, where there is a standing, limits must be set in order to provide an accurate percentile. These limits are purely at the discretion of the person or entity sponsoring or otherwise running the activity or otherwise collecting the activity score (sponsor).

Example #1 (extended) OBJECTIVE: Let's say one-hundred (100) runners compete in a race, and their “place” as they cross the finish line determines their standing. The sponsor can set a limit to the number of participants chosen to have their standing translated—including using all one-hundred (100); however, ten (10) or three (3) or another number can be considered the limit. That limit represents a set of participants.

Let's use ten (1.0) as our limit-set which means that the sponsor could determine that: <(first place receives 100%, second place receives 90%, third place receives 80% . . . tenth place receives 10%)>. An alternate example using all participants: <(first through tenth places 100%, eleventh through twentieth places 90%, twenty-first through thirtieth places 80% . . . ninety-first through one-hundredth places 10%)> and etc. with virtually endless possibilities.

Example of example #2 SUBJECTIVE: In the high-diver scenario, the maximum activity score is fifty (50) points. If the high-diver received three sevens (7s), one eight (8), and a ten (10) from the panel of judges, he or she has a score of thirty-nine (39) points. Each point is worth two percent (2%). His or her activity score percentile is seventy-eight percent (78%).

Example of example #3 PERCEIVED: The runner is running against the perceived maximum activity score of four minutes and forty-eight seconds (00:04:48). If he or she completes the mile in five minutes and six seconds (00:05:06), the well known formula for finding the percentage of a given number would require a limit. So, let's set the limit at six minutes and twenty-five seconds (00:06:25).

The first calculation is to determine the range of “times” or scores between our limit and the maximum activity score. The absolute range is one minute and thirty-seven seconds (00:01:37): ninety-seven seconds (97 s). Next, the runner's time is located along the range at (97 s minus eighteen seconds (18 s)) which equals seventy-nine seconds (79 s) from the start of the range limit of six minutes and twenty-five seconds. Now, the well known formula can be used:

79/97=n/100: (formula omitted) rounding to the ones place, the activity score percentile is eighty-one percent (81%).

So, whether the score is objective, subjective, or perceived, the activity score and corresponding activity score percentile are easily produced and ready to translate.

Translation can be achieved manually or through various automated means. Today's patent application is focusing on a specific moment in the process as the starting boundary for the scope of the claims. This starting point is referred to as the “translation intersection point” (TIP).

The TIP of the “activity score translation” (AST) process is the point where the activity score (or activity score percentile) is introduced to, and realized in reference to, the game or simulator's mechanics.

So, whether the activity score is converted into the activity score percentile (manually or automatically) prior to being introduced to the mechanics of the game or simulator, or the activity score is converted into the activity score percentile by the mechanics of the game or simulator (predefined and/or entered in as separate input), it is in-fact that moment of introduction of either the activity score or the activity score percentile that defines the TIP of today's patent application's process.

The process of activity score translation (AST) takes place from the translation intersection point (TIP) throughout the life-cycle of the activity score or activity score translation until the activity score or activity score percentile is “spent.”

The term “spent” means that whether the activity score has been translated into a game or simulator object or game or simulator object enhancement, or unlocks the use of a pre-existing object or enhancement (i.e. some positive, negative, or neutral attribute of the object) with a predefined one-to-one (1:1 or variant) translation, or the activity score percentile is translated into a game or simulator object, an enhancement, or unlocks a pre-existing object or enhancement based on (and at some degree of) an object's maximum enhancement potential (a static or dynamic limit), the activity score or activity score percentile has been used for its intended purpose: to create, allow use of, or enhance game and simulator objects based on real-life achievements and/or aptitudes that are perfected or realized extrinsic to the game or simulator's environment.

Therefore, the AST process is narrowly defined within a distinct scope that starts with the TIP and is perfected or executed when the activity score or activity score percentile is spent.

### PRIOR SURROUNDING ART AND SOME OF ITS DISADVANTAGES

The prior art which most identifies with the games and simulators surrounding the embodiments herein can be broken down into three categories; however, I believe that there is no prior art similar to the Activity Score Translation (AST) process:
1) Games that are designed and developed for the purpose of teaching one or more curricula which is typically static. These games often use aesthetics that correspond to the themes being taught. “Oregon Trail” released on the Apple II computer, decades ago, is a prime example of this genre.

One of the downfalls of games, like Oregon Trail but not necessarily including it, is that the story-line and visual elements often become novel and don't represent the truth; the desires of marketing and business distort the product in order to make it appealing and playable.

In my opinion, the greatest problem with learning-games, generally, is that the intended purpose of the game itself is to teach something real, so the players are constantly being reminded that they are not actually engaging in a virtual activity free from the real-world. I believe these games can never achieve the seamless feeling of adventure, the escape from the trials of daily life, or the end-game experiences known to some of the most popular video games played today by millions of people world wide such as massive multi-player online roll playing games (MMORPGs).

You can't just stop in the middle of a boss fight with twenty-four fellow guild members and wrack your brain over a calculus problem without greatly distracting from the fun and experience; immersion requires the absence of cognizant learning.

The awareness of learning and working through problems not directly associated with a given gaming universe simply do not mix with the fantastic worlds we enjoy playing games in—it destroys the fun, purpose, and excitement.

As for the other non-academic activities linked to the embodiments herein, they are impossible under normal circumstances. You can't just put down a joystick and head down to the recreation center to take a couple of high dives to boost your defenses while playing a game; real-life activities are separate (generally) from games;
2) The “KINECT” genre of games and simulators, found on Microsoft's X-BOX, are partly designed to integrate activities, such as exercise, dancing, shooting, playing musical instruments, and etc., in games or simulations and can be construed as prior art; however, they achieve the exact opposite of the AST process: they require the player or performer to engage in a quasi-real experience while connected to and engaged with the game or simulator, yet they don't actually compel them to engage in real-life activity; they don't go outside of the game, and the distinction between virtual and real is muddled in my opinion;
3) The majority of the games on the market today, and historically in my experience, are developed and designed to free the players from real-life and just have fun. Designers and developers are free to tell outrageous stories, create fantastic universes, and produce platforms for people to truly escape the trials of real-life; and the designers and developers need not be concerned with anything else such as learning or curricula. Budget and target markets are typically some of their top concerns—not state core standards which would surely distract from their creativity and production.

When looking at the three examples above, I must conclude that it is my belief that the negative impact of the gaming industry outweighs the positive. It's profound, and I have experienced it myself. As the WebMD article I pointed to earlier suggests, the games of today can have destructive effects on human life; and although children are a primary concern, adults fall prey to the addiction as well: all people are included, and in my opinion, all people are susceptible to gaming addiction at varying degrees.

Perhaps the most popular game on the market today, “WORLD OF WARCRAFT” developed by Blizzard Entertainment, is exemplary of the gaming addiction phenomenon. The game allows players to free themselves of daily life by completely immersing an avatar in fantastic realms having names such as are called Outland and Azeroth, and these fantastic worlds are not bound to any academic parameters. The players are virtually free to adventure in a massive multi-player environment.

While playing MMORPGs, my grades in school dropped, my social life dwindled, my home life suffered, and I spent most of my time in front of the computer screen; in fact, I spent over four-hundred (400) days, literally, over a three year period playing just one of my many characters.

Question: What did I gain? Answer: Nothing!

The games of today are equally as addicting, in my opinion, as alcohol, drugs, and gambling. While heavily involved with an MMORPG guild, our guild leader went through a divorce during one of our lengthy campaigns. His wife's excuse for leaving: “That damn game!”

### SUMMARY

The Activity Score Translation (AST) process is a (manual or automated) conduit of connectivity for staging human aptitude and skill level by translating real-life activity scores which are achieved exogenously from gaming and simulation environments into gaming and simulation environments to allow the use of, creation of, and enhancement of game and simulator objects which are used, seen, and realized by the game player or simulator operator during game play or simulation exercises.

For example, how much more do you think a student is going to study for his or her Driver's Education Training test if they knew that their results were going to be translated into a CADILLAC or FERRARI instead of a WINNEBAGO or station wagon for their upcoming driver simulation session? Does a visual representation of a student's academic and sports performance raise the level of peer pressure on a student?

I have also thought about handicapped persons. Where do they fit in? These questions are important, but they are beyond the scope of today's patent application.

### ADVANTAGES

The term “games” in this advantages section refers to pen, ink, and paper games, tabletop games, video games, and simulators which utilize the Activity Score Translation (AST) process. The term “garners” in this advantages section refers to individuals, groups or entities that play or use pen, ink, and paper games, tabletop games, video games, and simulators which use the Activity Score Translation (AST) process. The term “gaming” includes the participation in games and simulator exercises throughout this advantages section.

Accordingly, several advantages of one or more aspects are as follows:

a) Games are not limited due to curricula and the dynamics of presenting a learning experience mixed with a gaming experience; developers have more creative freedom while providing a positive platform for people to learn and grow;

b) The games themselves can be designed to focus on the virtual-reality or fantasy aspect of the environments they portrait while the academics or otherwise activities attached to the program can stay in the classroom (per se); or a mixed concept can be used to reduce academic interference in the gaming experience;

c) Parents will have the option to allow their children to play games that contain the generally addicting features of the most popular games while knowing the games using the AST process will likely harness those addictive behaviors and compel their children (and I believe all humans who play games) to participate in traditional or otherwise real-life activities such as academics, career-based learning, sports and indoor/outdoor recreation;

d) Curricula can be developed for each individual or group based on their needs or desires while multiple players and groups can utilize the same games simultaneously (or not) using different, several, curricula; or the curriculum can be the same for all garners;

e) Parents, educators, and others can input specific curricula into the games, so it can be said that the AST process allows and promotes polymorphic or generic use which broadens the target market of games which benefits the manufacturers, developers, designers, clients, customers, or otherwise target or interested groups;

f) The feeling of accomplishment is greater for a person playing a game that utilizes the AST process because the objects and object enhancements at their disposal, or associated with them in the virtual environment, are a reflection of their real-life achievements—and this is huge folks!

g) Real-life aptitude and activities that would normally seem to be of no use to a person (especially a child or youth (e.g. trigonometry scores of an eighth-grader)) are suddenly meaningful and useful. I am convinced that many people, including children and youths, will study like never before in order to acquire the virtual objects and enhancements in games that utilize the AST process;

h) People will have more incentive to excel in academics and performance because their results (scores represented by objects) will be on display in the virtual worlds they frequent and are frequented by others:

i) I believe that these games provide a bona fide reason for parents, educators, and others to encourage people of all ages to continue playing games which reflects positively on the gaming market and consumer opinion of the industry;

j) I believe that parents, educators, and others that choose games for, or are in proximity with, children, students and others will have a bona fide reason to become involved in the play and participation of students, children, and others which promotes greater bonds, relationships, and amounts of time spent between them;

k) I believe that family members, friends, professionals, and others in relationships with garners who utilize the AST process will likely appreciate and recognize the changes in garners who are spending more time participating in real-life activities while gaining real knowledge and having real experiences. The AST process, in my opinion, strengthens the family and community;

l) I believe that garners who use the AST process will become more sociable and socially accepted by others because the games compel them to engage in real-life activities;

m) I believe that games that are developed to use the AST process which also require reoccurring testing will compel and promote game players to maintain knowledge, hold information, acquire better skills and overall have increased efficiency. The AST process, when subject matter is reiterated, makes the garners “own” the knowledge and skills they acquire (in a sense);

n) Psychiatrists and otherwise gaming addiction doctors and counselors will have an alternative to just telling their clients to quit playing games. They can recommend or supply their clients with games that utilize the AST process.

Because the Activity Score Translation (AST) process is applicable to so many applications, a full list of advantages is too great to exemplify here in my opinion.

NOTE: I refer to exhibit games in the next sections; however, the exhibit games are not included along with this patent application. The exhibit games are only referenced to add clarity and flow to my explanations of the figures and references.

I am contemplating five distinct embodiments:

1) Manual to Manual;

2) Automated to Automated;

3) Manual to Automated;

4) Automated to Manual; and

5) Hybrid: any combinations of the above 1 through 4.

Because there is a definite gray area between the terms manual and automated, I am contemplating that these five embodiments cover the entire spectrum of possibilities. The point at which something becomes automated is genuinely subjective and beyond the scope of this patent application's specification.

I have included a description of a Manual to Manual AST process and an Automated to Automated AST process while the other three (3, 4, and 5 above) are only briefly described. Pen, ink, and paper, and tabletop games are generally thought of as manual while video games and simulations are automated for the most part; these concepts have much intersection.

### DRAWINGS' FIGURES

Although there are no patent drawings (per se), I have included some visual aids and placed them in a patent drawing format. These visual aids include a two-sided card that represents a game object (Cape of the Lion); and some programming source code is included as well to exemplify an automated process.

FIG. 1, on sheet 1/24, is the card that shows the front-side of a game object: Cape of the Lion. For simplicity, this game object only has three distinct enhancement elements (or attributes); these elements show the maximum potential of the Cape of the Lion game object.

FIG. 2, on sheet 2/24, is the back-side of the Cape of the Lion card. It provides more detail to include the test scores needed to activate the game object's enhancements.

### DRAWINGS' REFERENCE NUMBERS

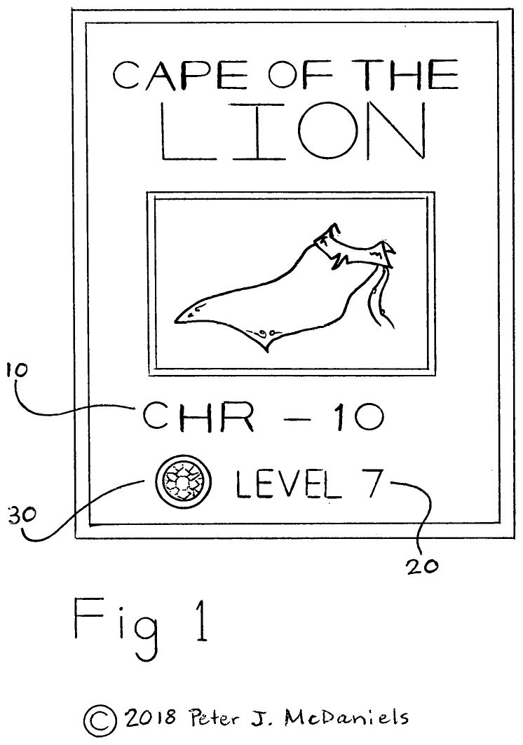

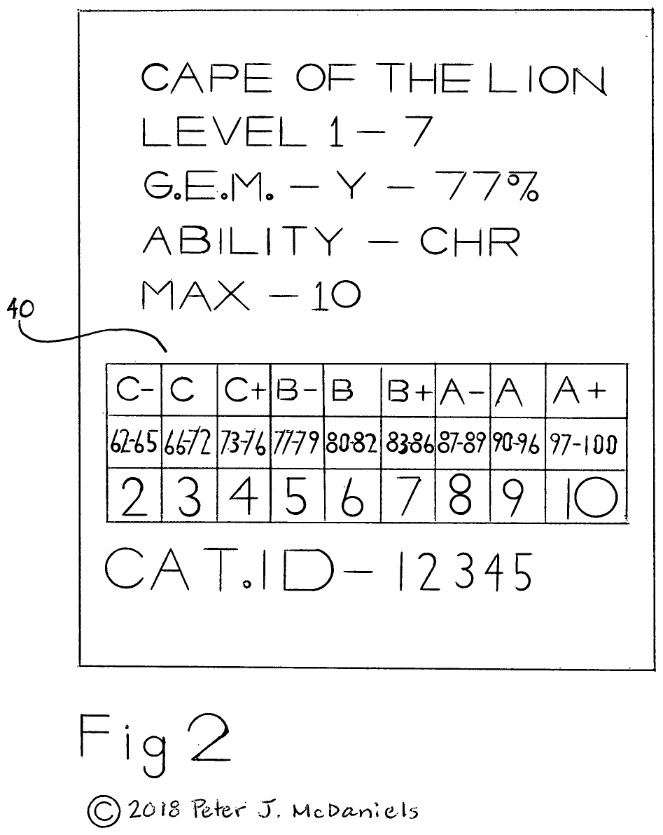

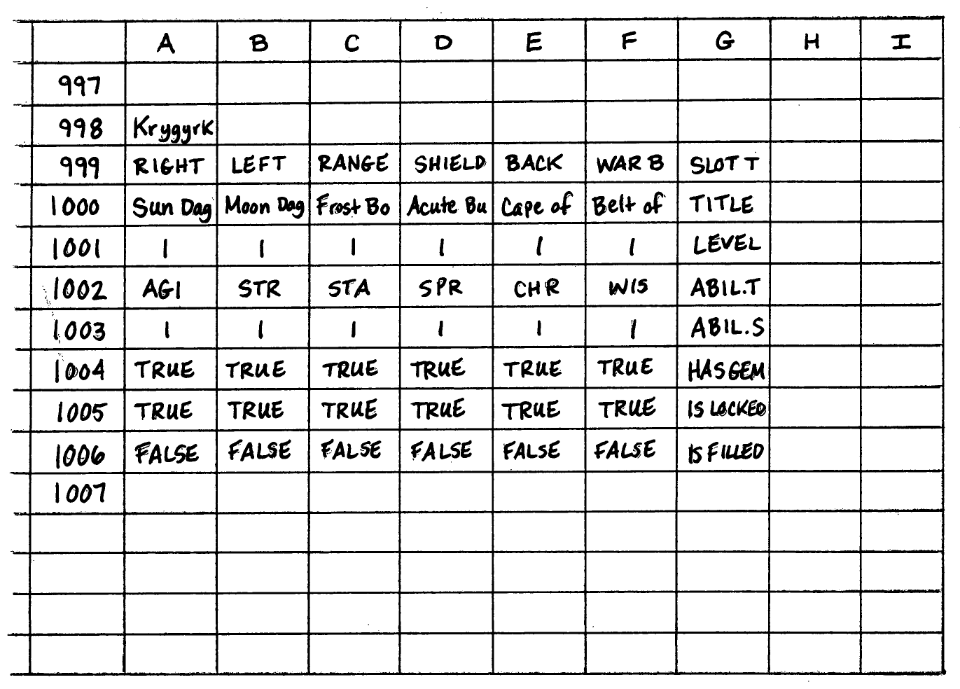

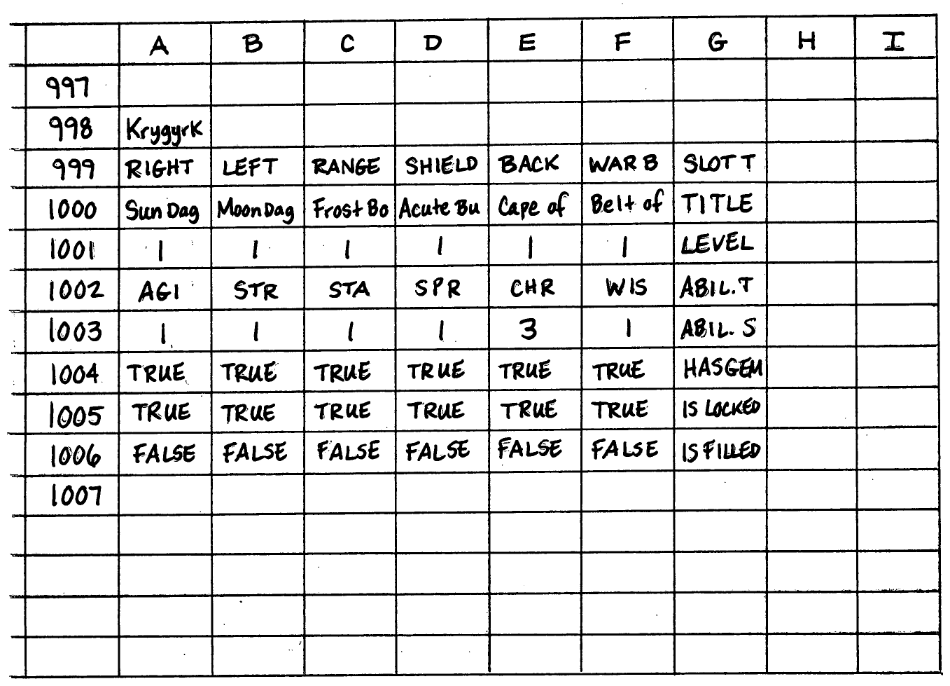

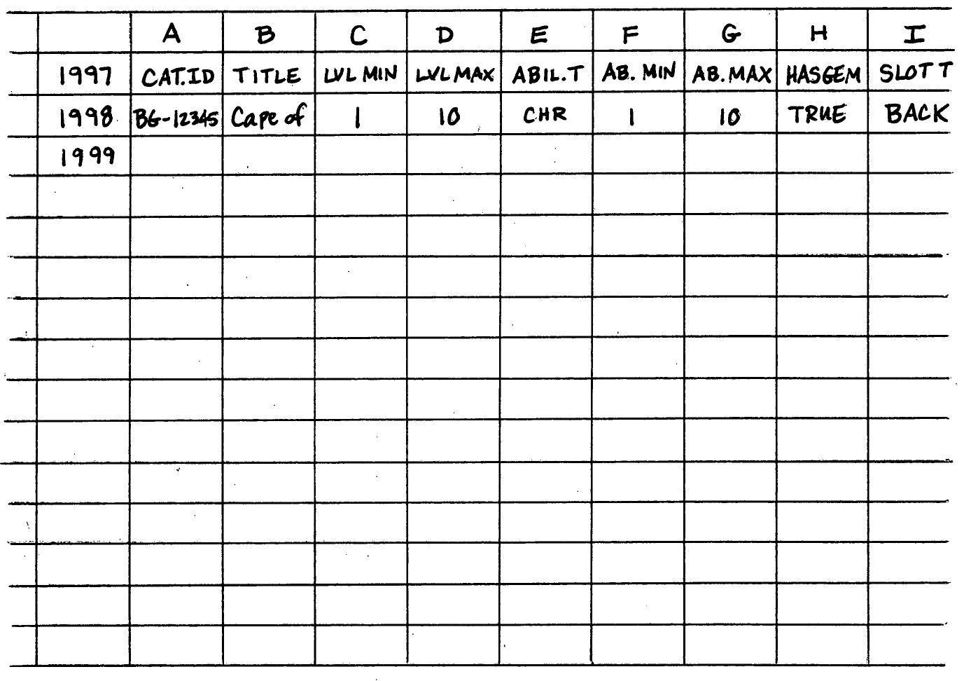

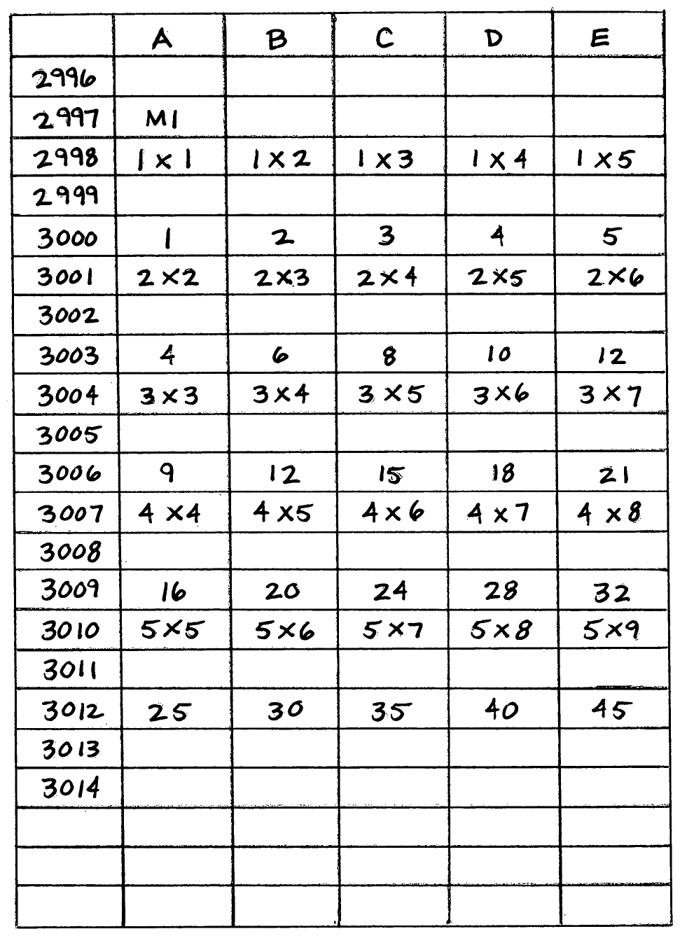

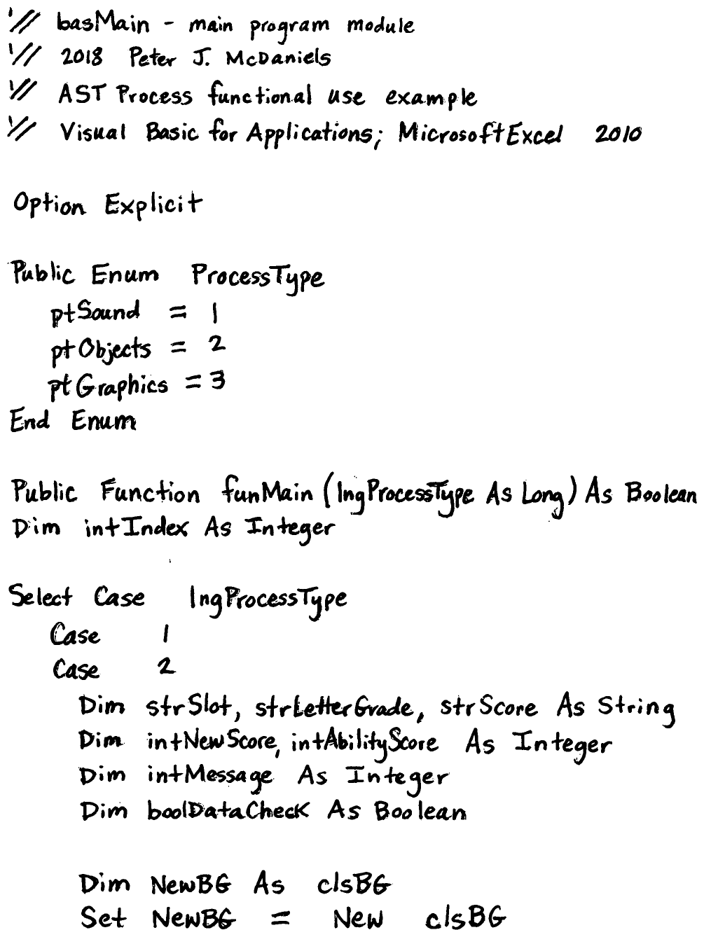

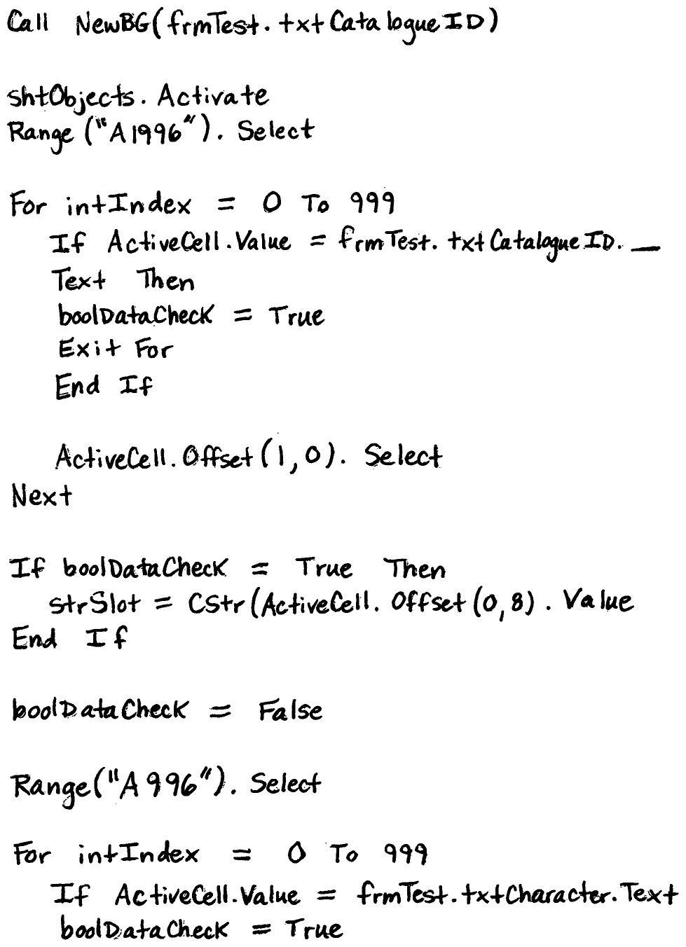

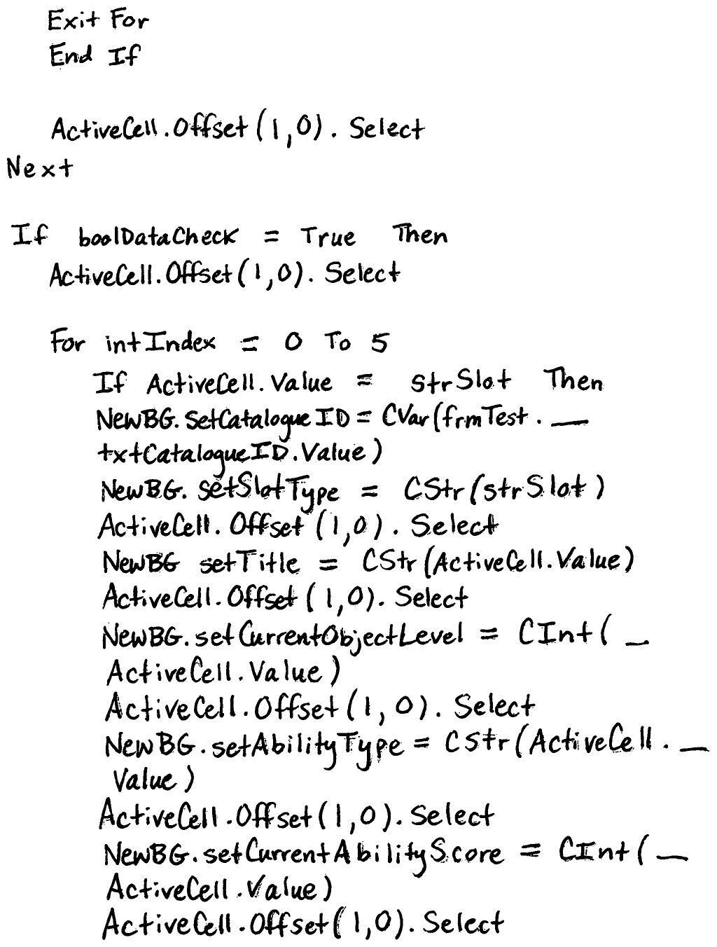

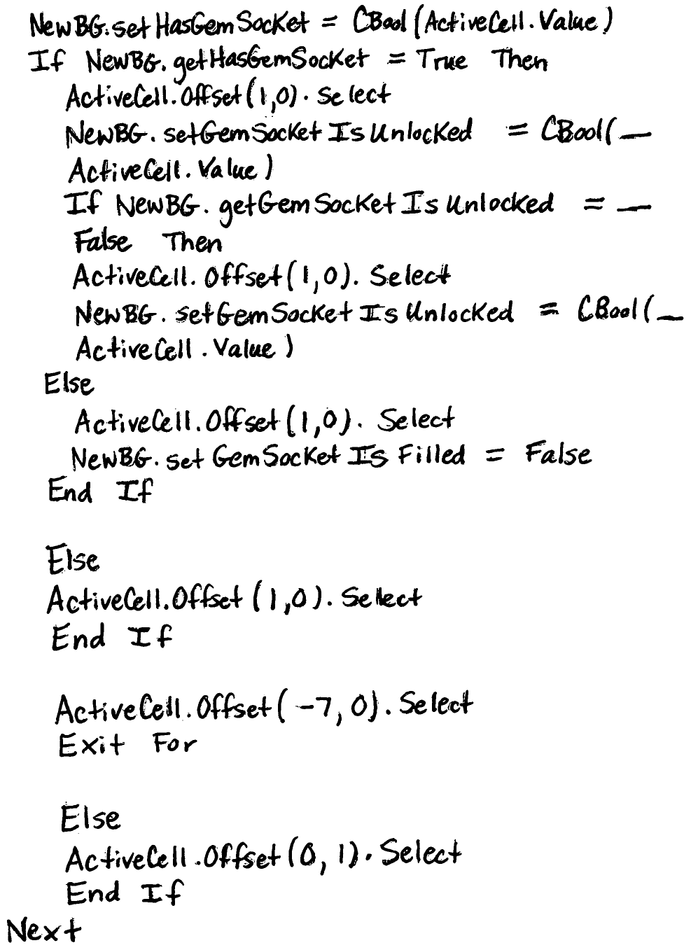

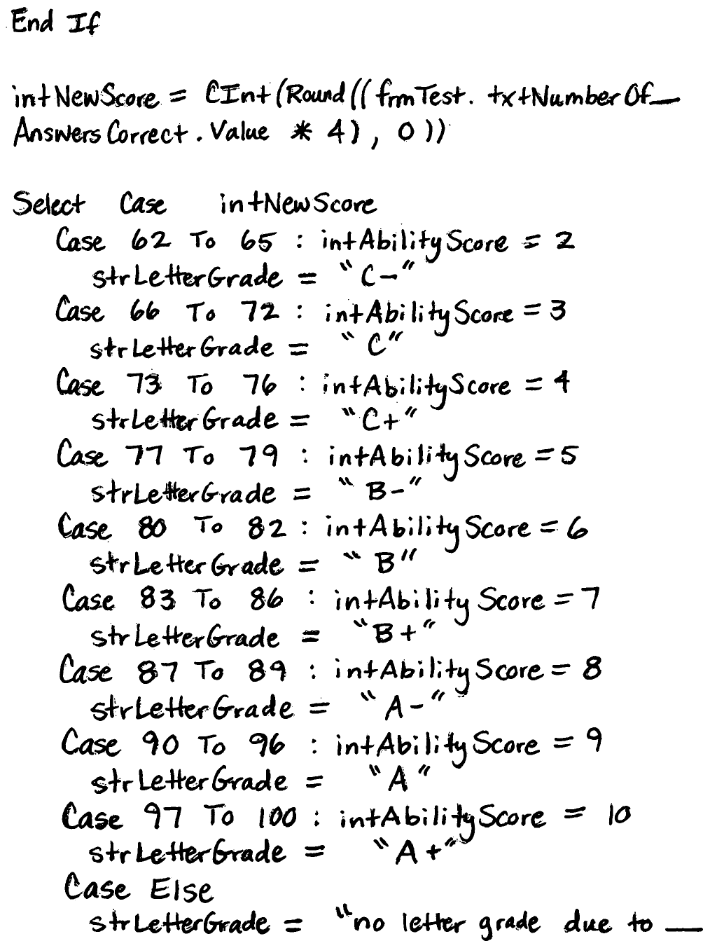

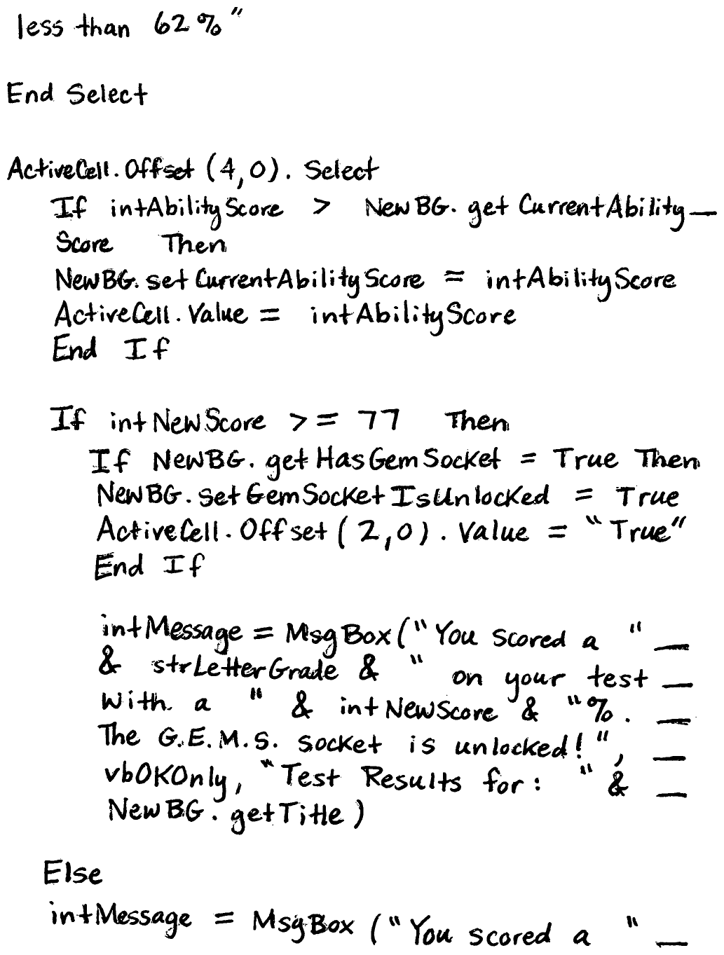

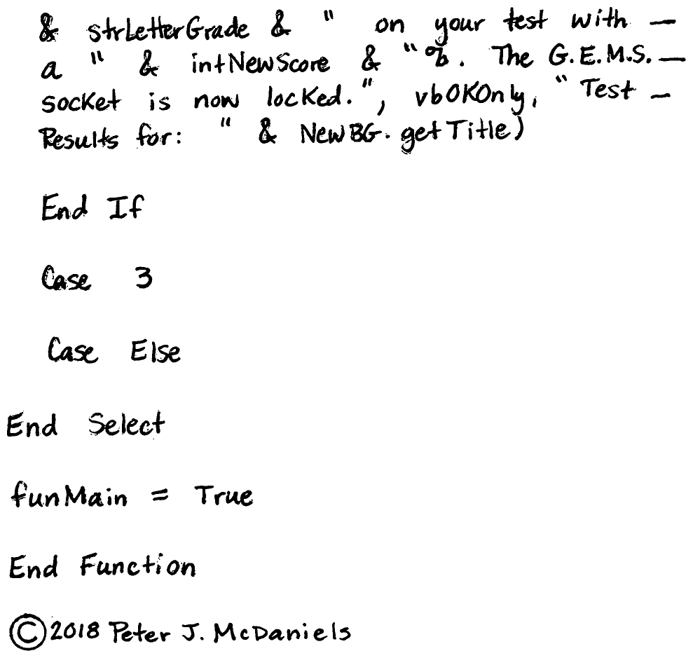

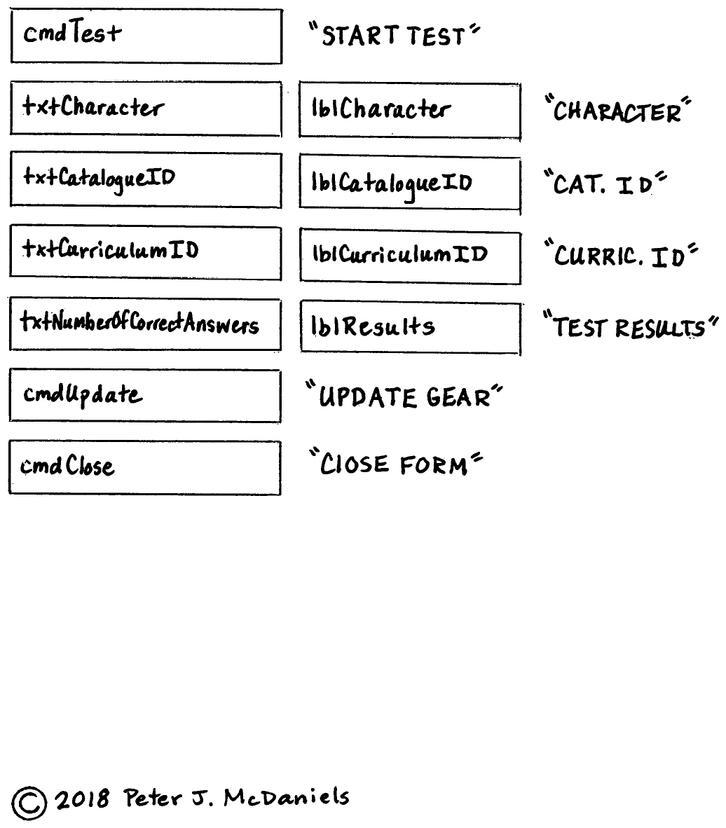

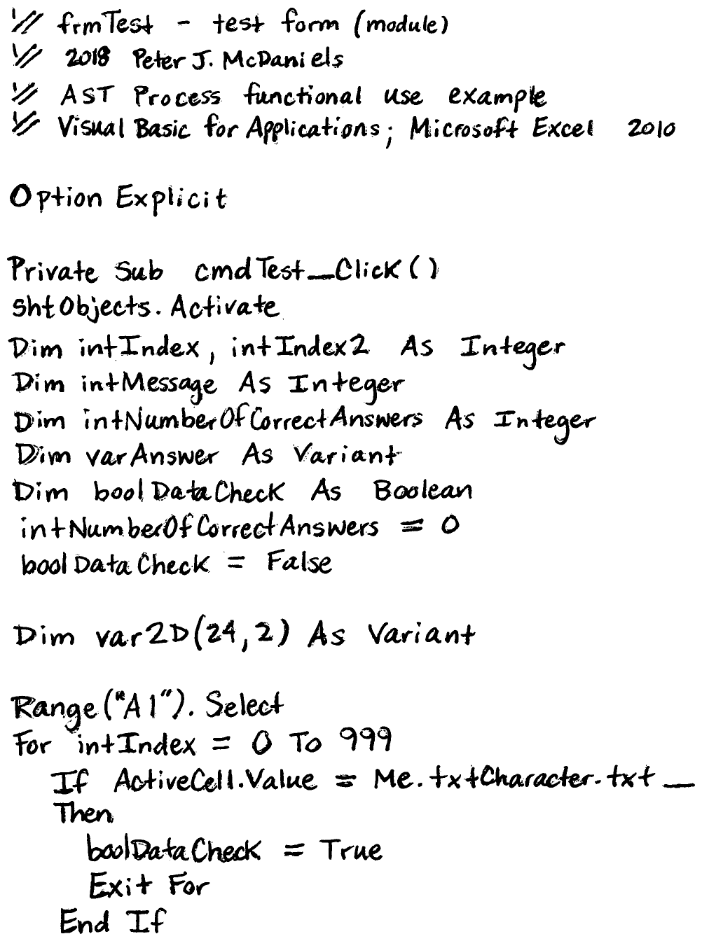

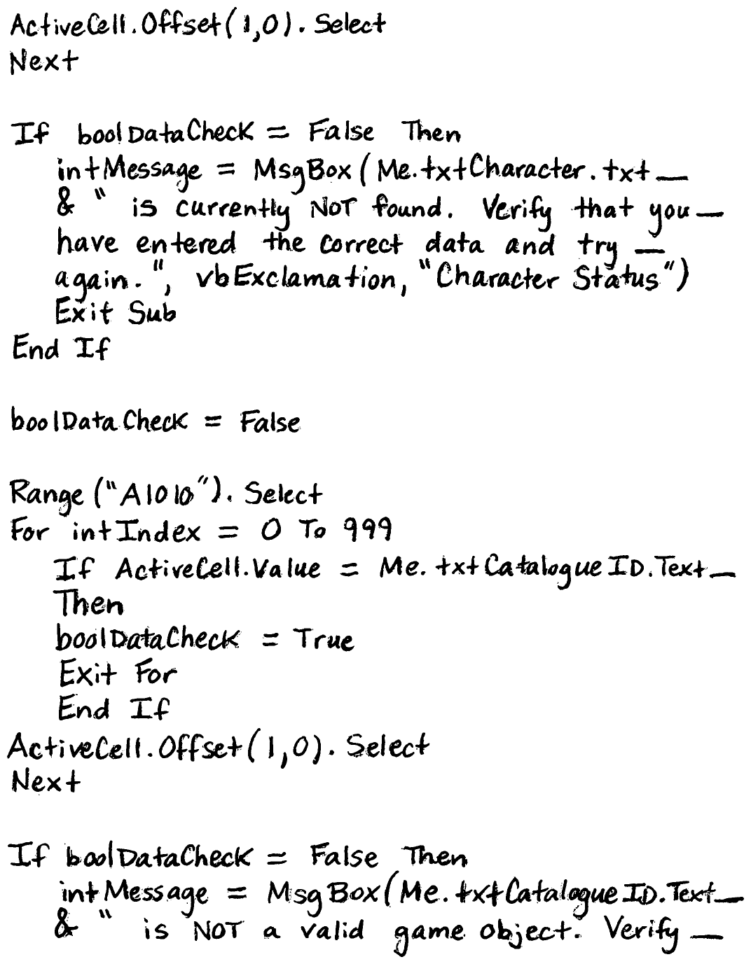

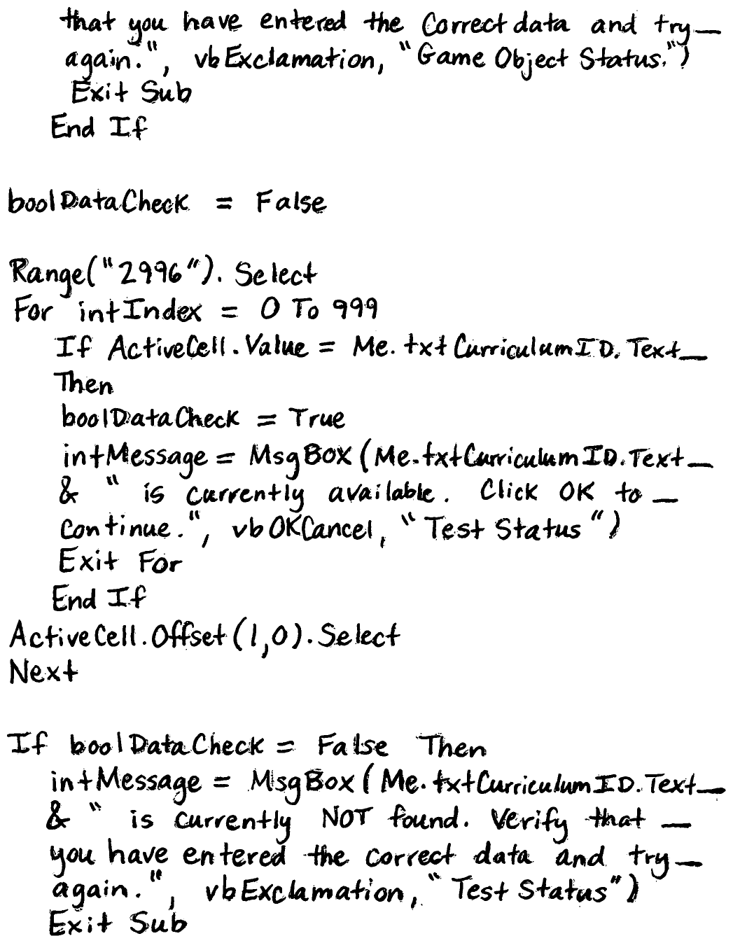

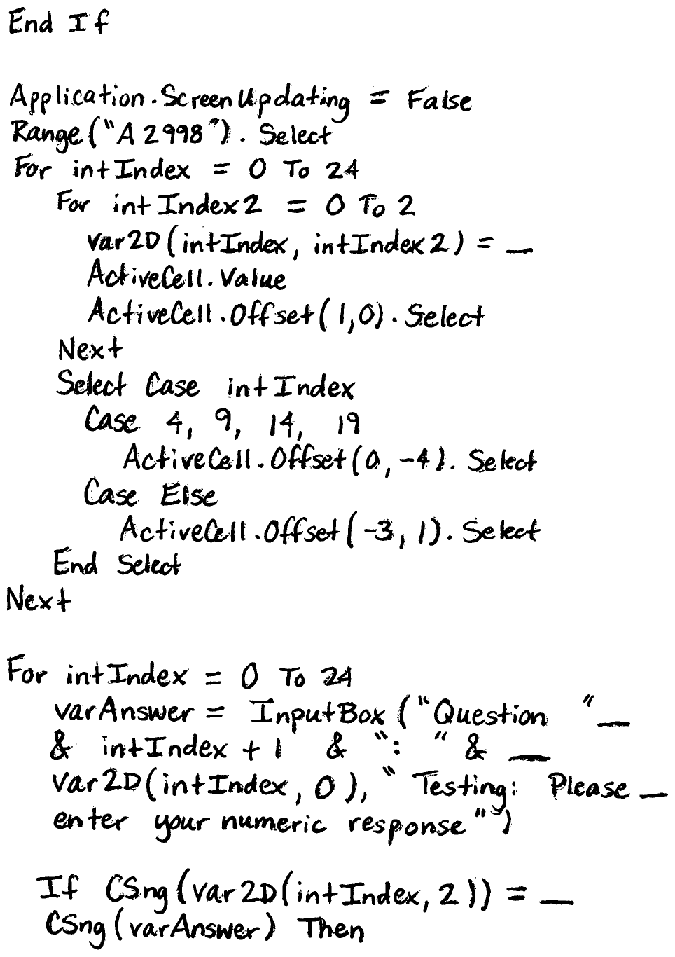

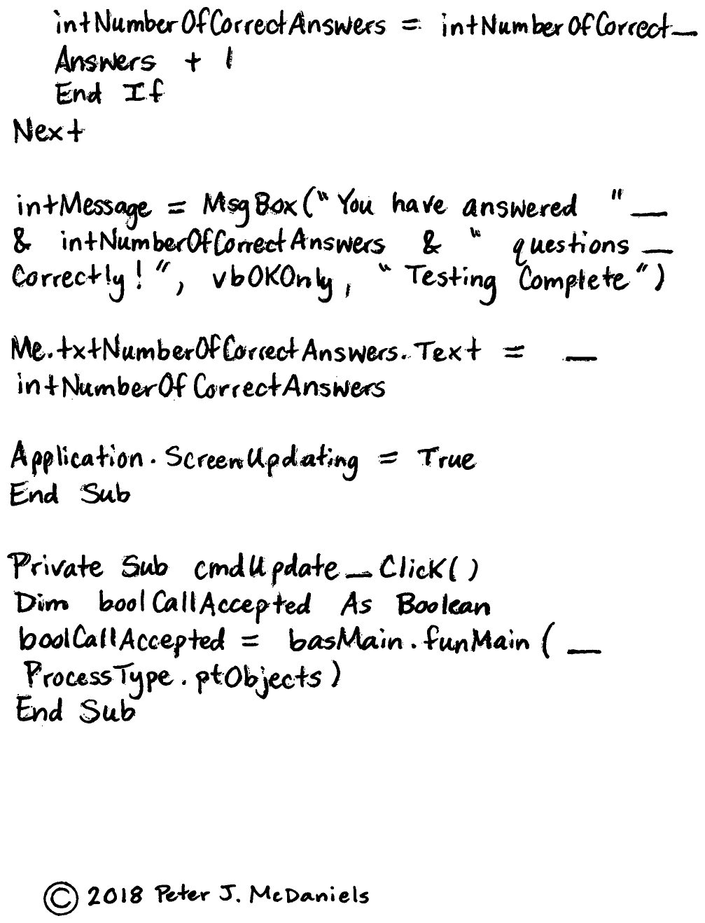

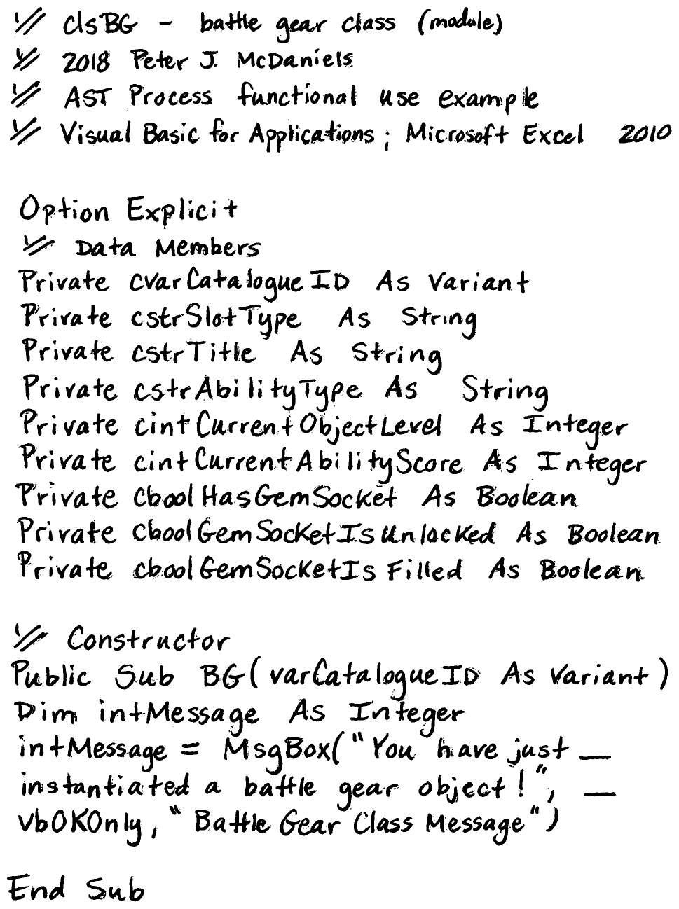

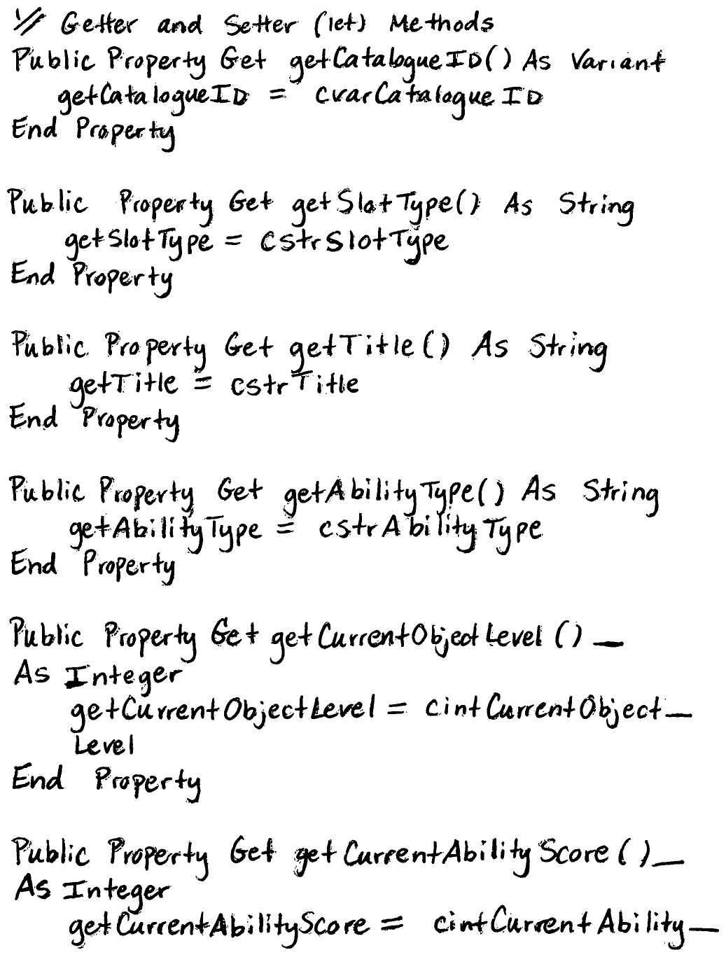

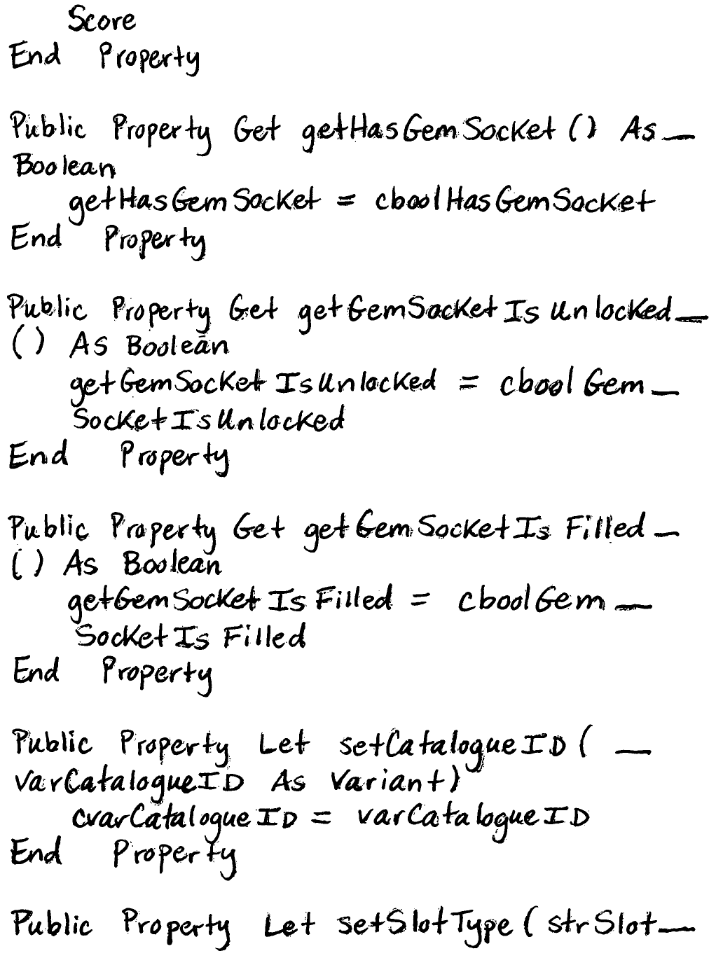

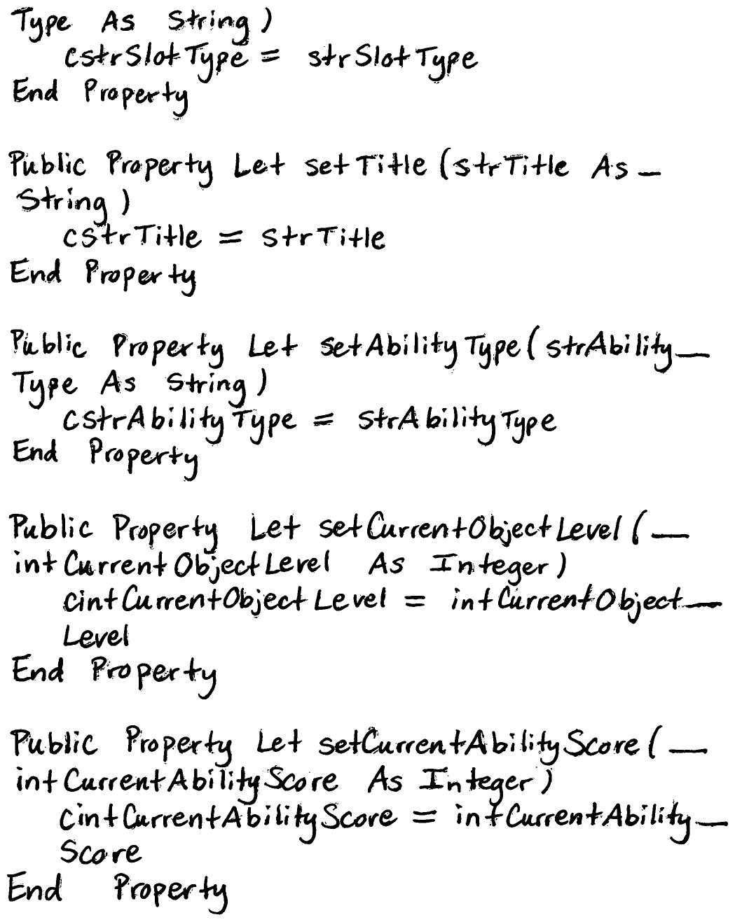

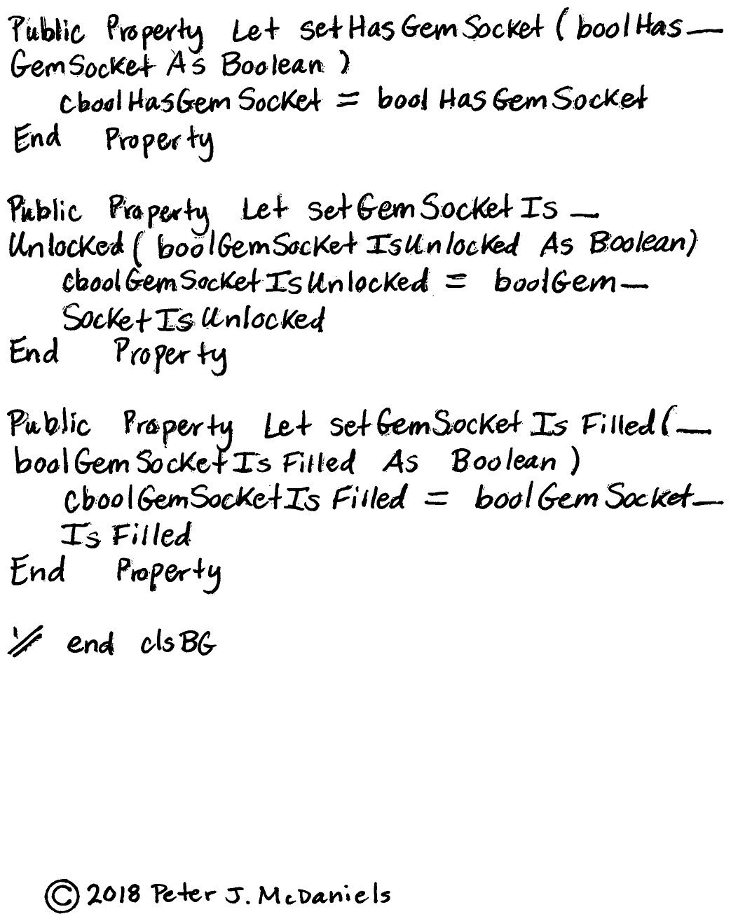

10, 20, and 30 are on FIG. 1; 40 is on FIG. 2:

Reference number 10 is an ability score known in the gaming industry as Charisma (CHR), and it has a maximum potential score of ten (10);

Reference number 20 shows the object level of the Cape of the Lion listed as seven (7) on the card. In many games, this level designation means that the object cannot be worn by or used by a player's character (or avatar) unless he, she, or it is at least of that same level or higher;

Reference number 30 is a G.E.M.S. socket (geometrically engineered magnification system) that can be filled with various G.E.M.S. objects in an exhibit game I spoke of above. G.E.M.S. enhance game-play in one or more ways. Think of them as adding random access memory (RAM) to a computer in a simulation or some other enhancement;

Reference number 40 is a section on the back of the Cape of the Lion Card that shows the test grades that correspond with the potential enhancements attached to this game object which can be unlocked for use once that corresponding test score is achieved.

All of the references on the front of the card, 10, 20, and 30, show the maximum; however, in one of the exhibit game examples I am contemplating and used to test the AST process on my own, the objects' enhancements (i.e. attributes, elements, etc.) start at their minimum potential.

I call these Bare Bones objects—meaning that they can be used, but their contribution to the overall performance of a player's character, avatar, or otherwise parent object is minimal; this concept applies to the aesthetics and other objects and object enhancements as well: emotes that express something meaningful or mundane such as sound, color, and actions etc.

An example of how color works is that the object starts out in gray-scale, but once unlocked through testing outside the game, the color becomes an attractive hue; in one exhibit game I am contemplating to test the AST process, color is used to denote rank (or current grade) of game objects. This concept is a gaming industry standard. Color is not just aesthetic in nature; it also signifies status and performance.

Another method for utilizing the test scores on objects is to have the object or object enhancements not usable at all until they are unlocked or created through testing outside the game or simulation.

The remaining sheets three (3) through twenty-four (24), 3-24/24, do not include figures or numbers because it is not necessary; they are all well known components of Microsoft's EXCEL 2010 application containing my source code and data to exemplify an alternate (automated) embodiment.

The included embodiments (manual and automated) use the Cape of the Lion object, and the slight difference between the two is that the automated version has a maximum level of ten (10) while the manual version's is seven (7) as stated above; this is irrelevant because the numbers or otherwise object enhancements can be anything found inside of pen, ink, and paper games, tabletop games, video games, and simulations.

### Manual to Manual AST Process

When a player acquires the Cape of the Lion (in one variation of my exhibit games as an example of how the AST process works) the potential of the object is at its minimum; the charisma ability and the level are at one (1) while the G.E.M.S. socket is locked and empty.

Through testing (or otherwise activities that produce scores), the potential of the ability score, the level, and the use of the G.E.M.S. socket can be increased and unlocked which enhance the performance and status of the player through their character, avatar, or otherwise parent game object. Here (in my above mentioned exhibit game) charisma is used in both combat and social (non combat) encounters.

As highlighted in the advantages section above, different activities' scores can be translated to enhance the Cape of the Lion; I can use an outdoor activity one day such as running, jumping, skiing etc., and the next day I can use an academic activity.

Today's example uses mathematics; however, all activities, including academics and serious activities, such as found in the professional and skilled-trade world, can be used.

One version of the exhibit game, a pen, ink, and paper (booklet) game, has an appendix with 500 math problems and several predefined tests; however, there are directions that tell the user how to design their own curriculum and tests as well to include outdoor, recreational, and otherwise indoor/outdoor activities aside from academics.

Here is how it works:

The player studies the course material provided (or not), or he or she can utilize study materials from elsewhere, or both. The player then takes a test on twenty-five (25) of the math problems (any reasonable number of problems or questions works).

The player completes the test, and their test results (in this example of my first embodiment) show that he or she solves eighteen (18) of the math problems with the correct answer. Twenty-five (25) is the maximum activity score, so eighteen (18) correct answers translates into seventy-two percent (72%) which can be referred to as the activity score percentile.

The player and parent, person, or otherwise sponsor look to the back of the Cape of the Lion card (FIG. 2, on sheet 2/24) to find what enhancements have been increased (or decreased) and unlocked; see reference number 40.

The card shows that seventy-two (72%) gives a “C” grade and unlocks three (3) of the charisma (CHR) ability points; however, the G.E.M.S. socket/slot (object) is not unlocked because a “B−” or better grade is required to do so.

The player can now utilize the charisma (CHR) enhancements in the game which are (currently) used in both combat and social encounters in many of the various exhibit games I am contemplating.

The player also has the incentive to keep studying and testing in order to unlock more of the Cape of the Lion's potential, The player, likewise, must continue testing on material in order to maintain the enhancements. This helps a person retain the information they learn; or alternately, once the enhancement is acquired, it is a permanent feature; or the maintenance can diminish or have some other means of executing the enhancements.

Eventually, the player can replace the Cape of the Lion with a better piece, or the game can increase the enhancement potential in some other way to open the door for more and variant testing. In one of the exhibit games I am contemplating, the Cape of the Lion can be upgraded using a process called Mutation which allows the player to fuse one or more game pieces into a better piece while maintaining their preferred aesthetics. New curriculum can be attached to the object, or the original math problems (500 etc.) can be maintained or both.

Activities not generally considered academic in nature, such as sports or otherwise, can be used as well in addition to the academics or as a stand alone activity used for the purpose of enhancing game (or simulation) objects. Within reason, there is no limit to the possibilities which gives all people access to the AST process.

The AST process compels people to participate in real-life activities; so for example, in several versions of the exhibit game, I have added mini courses that consist of small articles, an essay, a treatise, or other (project) activities.

These supporting activities can be triggered by the player finding or otherwise acquiring game objects in the game or simulation.

After opening up the mini course outside of the game and studying the material, the player can test on the information; or as in the case of a project, their work can be judged etc. The player's achievements can then be translated into the game or simulation environment. This concept I am contemplating can be used to support and supplement core state standards or other curriculum; or the mini courses' activities could be used as the sole source of exogenous input into enhancing the game or simulation.

Another example (other than the Mutation) I have coined is called Levolution; this concept is achieved by acquiring a seal (to close, lock, or fasten) object in the game and then studying and testing on the academic, trivial, or otherwise activity's material or objective in the case of physical activity, attached to the seal, while not playing the game or operating in the simulation.

This concept of separating the game and simulation world from the real world is vital to the process. The person testing can be on the same computer or at the same table the game or simulation is taking place on or at, but for all purposes, they are no longer participating in the game or simulation.

Some gaming forums refer to this as being “away from keyboard” (AFK), and I will add a variance of this term in the glossary to exemplify the separation of the game/simulation worlds and the real world the AST process compels people to participate in outside of the games and simulations they play and operate in.

The Seal of Levolution is used in a campaign in one of the exhibit games. The campaign is called The Whiskey Underground which leads players into a subterranean hideout and bootlegging operation in the year 2515. While questing underground, players defeat members of the Whiskey Syndicate (Aka: The Gentlemens Club).

Looting a random mobster after defeating it could yield a whiskey bottle cap (i.e. a seal) which tasks players to leave the game at their own leisure to participate in a mini course (one segment of a series) that covers material concerning the American Prohibition Era.

Once the mini course is complete, and an activity percentile (score) is received, the player can use the achievement to level up a game object: a piece of gear, unlock higher level game content, or even to level up the player's avatar character itself etc. I added this to show how diverse and compelling the AST process really is.

In other versions of the exhibit game, the activity scores are translated, but the value of the scores inside the game is used as currency of several types that are not required to be spent immediately. The player can stockpile (with limits if necessary) the points and use them at will, or a time limit can be set (or otherwise schedule/scheme) can be set to use the currency to enhance the game in various ways.

This first embodiment I am contemplating demonstrates a manual-to-manual AST process which means that there are no computer or otherwise automation systems in place or involved at all. It is the exact moment, whether written or expressed in other terms, that the activity score (and/or percentile) is applied to the game or simulation that narrowly defines the translation intersection point (TIP) of the AST life cycle and scope of today's patent application.

The duration of the AST process' life cycle depends on when the score (and/or percentile) is spent: that is, applied to game/simulation objects or enhancements; or the score or percentile is applied to other game features and/or their attributes.

The loss of use or exhaustion of the value of the score (and/or percentile) for the lack of use (due to a timer or otherwise condition) is another way of expressing that the AST process and life cycle is complete and the scores (and/or percentiles) have been spent.

The above briefing of a manual-to-manual embodiment, (again) is isolated to the TIP through the act of the activity score or activity score percentile being spent. The conduit for the transient extrinsic cause for embodying the real life activities of a human being in game or simulation objects or object enhancements is called the activity score translation (AST) process.

### Automated to Automated Alternate Embodiment

The next example is for an alternate embodiment which I am contemplating for an automated to automated AST process achieved with computer programming and application with user interaction. Any accessible computer platform can be used; and any relevant development environment can automate the AST process.

I am contemplating the following excerpt from a video game version of the aforementioned exhibit game developed in a highly programmable spreadsheet application: Microsoft's EXCEL 2010 and Visual Basic for Applications (VBA) is the programming language used to exemplify the automation of the AST process.

I am only including the game elements and separate activity elements to the extent that the reader can fully grasp the alternate embodiment I am contemplating.

The complexity of modern video game and computerized academic environments, UNITY and BLACKBOARD respectively as two of many examples, is beyond the scope of today's patent application although the translation intersection point (TIP) of the AST process is designed to bridge those two worlds: gaming and simulation with academics and other activities without interfering in one another needlessly.

My example below assumes that the player is leaving the game to take a test in order to upgrade his or her Cape of the Lion acquired in the game itself; however, the game object can be acquired outside the game and consequently introduced into the game as well.

Container objects used in the spreadsheet application:

1. shtObject—Spreadsheet (see drawing sheets 3-6/24).

2. basMain—Main program module (see drawing sheets 7-13/24).

3. frmTest—User interface form module (see drawing sheets 14-19/24).

4. clsBG—Battle Gear class module (see drawing sheets 20-24/24).

Quick directions:

STEP 1: Change the name of Sheet 1 (in a new Microsoft EXCEL 2010 workbook) to shtObject. Note: This must be done from the integrated development environment (IDE) and should not be confused with the tab label at the bottom of the spreadsheet itself.

STEP 2: From the toolbar in the IDE, click Insert and select a Module; name it basMain.

STEP 3: Click Insert again, and select a Form Module; name it frmTest.

STEP 4: Click Insert again, and select a Class Module; name it clsBG.

STEP 5: Enter the data on the shtObject spreadsheet:
a. See drawing FIG. 3 on sheet 3/24; this is the player character's equipment before the test is taken; enter the character's name “Krygyrk” in cell A:998 and then fill in the rest of the cells with the data provided. Cell E:1003 should be (1) one before the test is taken.
b. See drawing FIG. 5 on drawing sheet 5/24; this is the game object catalogue; enter “CAT. ID” in cell A:1997 and then the rest of the data provided. Cell A:1998, “BG-12345” is the only cell referenced from the program; the rest of the data is cosmetic, and some cells only show part of the data (e.g. B:1998 reads, “Cape of ” however, if the cell were to be expanded, it would read, “Cape of the Lion,” E:1997 would read, “ABIL. TYPE” which abbreviates ABILITY TYPE etc.
c. See drawing FIG. 6 on drawing sheet 6/24; this is the test taken exogenously from the game, and it is named, “M1” (m one) in cell A:2997, and the rest of the data is shown.

Note: I used a Command Button on frmTest (NOT shown on FIG. 7 drawing sheet 14/24) with a click event to enter all of the above data (a, b, c) in their corresponding cells; however, I did not include that code because entering the data manually simplifies the directions.

STEP 6: add the controls to the user interface frmTest. See drawing FIG. 7 drawing sheet 14/24.
a. Add a Command Button; and name it “cmdTest” while the Caption should read “START TEST.”
b. Add a Text Box; and name it “txtCharacter” while its Text should read “Krygyrk” so the user doesn't have to enter the character's name each time the program is run.

Note: Krygyrk is an end game boss in one variation of the exhibit game. He is an android (sic) robot, Lycan Kind (30 foot werewolf) designed to brutally defeat all but the very best equipped and skilled groups. When he (it) wipes out the raiding party, after going on a rampage, while slashing the video screen with claw marks, he growls, “Cry jerks, cry jerks, cry . . . ” (See Elitest Jerks online).
c. Add a (or copy and paste the previous) Text Box; and name it “txtCatalogueID” while its Text should read “BG-12345”.
d. Add a Text Box; and name it “txtCurriculumID” while its Text should read, “M1” (m one).
e. Add a Text Box; and name it “txtNumberOfCorrectAnswers” while its Text should be left blank.
f. Add a Command Button; and name it “cmdUpdate” while its Caption should read “UPDATE GEAR.”
g. The Close button and label objects (controls) are all optional; they can be added for readability.

7. At the top of the drawing sheets 7/24, 15/24, and 20/24 are the beginning of each of the three (3) code areas that need to be entered for basMain, frmTest, and clsBG (respectively).

In Visual Basic for Applications (VBA), the “'” apostrophe tick mark is used to enter comments. I prefer the two forward slashes “//” found in many true object oriented programming (oop) environments, so I have added them after the tick mark (i.e. “'//” for readability. The only comments used on these drawing sheets are at the top of 7, 15, and 20/24. No other comments are necessary because the code is simple and self explanatory.

IMPORTANT: On the code sheets, you will see underscores “_” used at the end of many of the lines of code; however, they should not be entered in the code window. These underscores “_” are telling the coder to continue typing the code from the next line following the underscore “_” on the same line where the underscore “_” rests.

I merely ran out of room and and had to continue on the next line. My goal was to keep as many sheets in portrait view as possible. These underscores “_” should not be confused with the underscore character that does in-fact allow code to be written on the next line in many coding environments. That is not the intention here.

The only true underscores in the entire code for this automated to automated AST process embodiment are in the “cmdTest” and “cmdUpdate” click events. I did not include code (me.Close) or the event for the cmdClose button; likewise, I did not use any formal error handling (Try, Catch, Throw etc.) because it is not necessary to test the functionality of an automated to automated embodiment of the AST process.

8. Once all of the spreadsheet data is filled in, the form and its controls are added; and all the code is entered, you are ready to take your test. The only discrepancy between the manual to manual (M to M) example and the automated to automated (A to A) Cape of the Lion example is the level cap. The M to M has it set at seven (7), as shown in FIGS. 1 and 2 while the A to A is set at ten (10) as seen in FIG. 5 at cell range D:1998; this discrepancy is irrelevant.

Again, make sure your text box control objects read: “Krygyrk” for txtCharacter, “BG-12345” for txtCatalogueID, and “M1” (m one) for txtCurriculumID.

9. Click the cmdTest button control (after running the program) and navigate through the test; if you prefer, you can step through it using the debugger.

10. Click the cmdUpdate button control to update your Cape of the Lion (back piece) object with its new enhancement value.

Keep in mind that FIG. 3 shows the Charisma (CHR) score for the Cape of the Lion (at cell range E:1003) before you take the test while FIG. 4 shows the change made (at cell range E:1003) which reflects a score of 18 out of 25 correct answers; you might score higher on the test and even unlock the G.E.M.S. slot: enjoy!

### GLOSSARY

activity—natural or normal function or operation as a process that an organism carries on or participates in by virtue of being alive; or any similar process that actually or potentially involves mental function; or (specifically) an educational procedure designed to stimulate learning by firsthand experience or observation, experiment, inquiry, and discussion; or an actuating force; or a creative agency or process; or an occupation, pursuit, recreation, or performance in which a person is active; or a form of organized, supervised, and or often extracurricular recreation . . .

AFK—“away from keyboard” is used to describe the fact that a person is no longer engaged in a game or simulation; or they are not present in the game or simulation. In the Online gaming industry, the term means that a person is not responsive to the other players or the environment, or at least, it appears that they are not still playing the game. The variance in today's patent application is not too much different than the common understanding of the acronym itself.

The slight variance means that the exogenous activity used to enhance the gaming and simulation environments is not performed as part of the game, so the game does not in any way rely upon any immediate exogenous activity in order to maintain functionality. The game and exogenous activity are independent of one another although the latter can be used to enhance the former at a specific or nonspecific time. Simply put, the player or participant is not playing or participating in the game, nor is their immediate attention to the exogenous activity required to continue playing the game as this would defeat one of the primary purposes of gaming: to play without the burdens of real-life interfering in the experience at the time.

analytic—broken down into parts.

automatic—involuntary either wholly or to a major extent so that any activity of the will is largely negligible; without volition; like or suggestive of an automaton; mechanical; performed without conscious awareness; able to move and act in total independence of any outside cause; having the power of motion and action entirely within self; having self acting or self regulating mechanism(s) that perform a required act at a predetermined point in an operation; marked by spontaneous or apparently spontaneous action; marked by action that is unpremeditated and that arises as a really or apparently necessary reaction to or consequence of a given set of circumstances.

avatar—see character.

bare bones—the basic structure of the object without any or with only some enhancement or functionality:
a. the basic structure of an object without any enhancements;
b. the basic structure of an object with only one or some enhancements;
c. the basic structure of an object with no functionality;
d. the basic structure of an object with only partial functionality;
f. the basic outline of an object without any details or otherwise attributes;
g. the basic outline of an object with only one or some details or otherwise attributes;
h. any combination of the above; or

The barest essentials, facts, or elements to include point, line, plane, form, space, and time.

boss fight—an encounter in a role playing game that includes a more difficult to defeat opponent: literally the boss or like entities or more formidable opponents.

constellation—a collection of parts related to one another or not.

character—the character in a gaming or simulation environment is that parent object(s) that is controlled by the real flesh and blood person playing or participating in the game or simulation (AVATAR).

conundrum—a question, problem, puzzle, or riddle based on the resemblance between things quite unlike and forming a puzzling question whose answer is or contains a pun or pun-like terms aligned with or in opposition to the original question.

end game—the final stage of a game such as chess or bridge, when few pieces or cards remain; the last stage (as the last three tricks) in playing a bridge hand; the final phase of a board game; the stage in chess following a serious reduction of forces; also, the finale of a gaming experience where the risk and stakes are typically higher, the content is more difficult (sometimes requiring input and cooperation of multiple players); and the rewards are greater providing a significant increase in enhancement potential to the player's character/avatar/parent object(s) such as better game items allotted as rewards or otherwise acquired; access to new content, titles, currency, and other highly sought after game objects and their attributes.

Also, an end game experience is one that has characteristics of end game activity through the viewpoint of the individual player, and this experience need not be the only finale of the game; end game experiences can take place at different stages of a game, and robust game development nurtures this cycling and recycling of end game activity to keep players engaged.

exogenous—growing from or on the outside; introduced from or produced outside of the organism. The opposite of endogenous which means to grow from within or on the inside; originating within.

enhancement—normal usage; however, in today's patent application, it can mean to change for the worse as well as the better; or stay the same as a result of introducing exogenous activity scores into a game or simulation; add, subtract, or neither.

functional equivalent—equates to the same thing; for example, baby formula is the functional equivalent of mother's breast milk; substitute whether proper or not.

game object—anything perceived within a gaming environment to include but not limited to objects and their attributes (SIMULATION OBJECT).

hard core gamer—a person playing games at the expense of other activities, real or otherwise, such as work, school, social interaction outside the game, eating, practicing good hygiene, and so on; to an extreme or less or more than that.

immanent effect—the result of something happening within.

level cap—the highest level that can be achieved by an object (or object's attribute) in a game or simulation.

manual—of, relating to, or involving the hands; designed for use or operation with the hands; worked by hand; requiring or involving physical skill and energy; engaged in an activity or occupation requiring or involving physical skill and energy; existing in fact or deed; the requiring of human organs of observation, effort, and decision.

parent object—in a parent child relationship, the parent object is the main object while child objects are subordinate, connected to, or reliant upon the parent object(s); example: in a role playing game, the parent object most commonly thought of is the player's character or avatar which is typically a humanoid, animal, or like form; however, it could be a ship or other object. Child objects are the armor, weapons, clothing, pets, and other objects said to be owned by or used by the parent object. Some parent objects may be completely comprised of child objects; the hull, sail, and crew are all subordinate to the parent “sailing vessel.”

raid—a raid is a type of gaming encounter where multiple players work together to obtain a goal or goals usually with opposing forces.

serious gaming—games or simulations used to teach and learn about real things (eg. a surgical procedure was taught using a computer simulation, so students could learn the procedure's basic elements without the need of a live patient).

transient extrinsic cause—a cause originating or having its effects outside an entity; contrasted with immanent cause—a cause originating and evolving within an entity.

Several of the foregoing terms and their definitions were derived in part or whole from the following three sources: Webster's Third New International Dictionary; Oxford Dictionary; and “The Multiplayer Classroom: Designing Coursework as a Game”, by Lee Sheldon, Cengage Learning 2012.

See also Webster's Third New International Dictionary for more general and specific definitions to increase understanding of the words and terms I have used in today's patent application for the activity score translation (AST) process.

The terms and definitions herein are meant to be a general guide to the intent of their use and are not to be construed as limiting the scope of my claims.

1. What is claimed is the activity score translation process is a method for staging human aptitude, skill, and performance, measured exogenously from pen ink and paper game, video game, and simulation environments, in said pen ink and paper game, video game, and simulation environments:
a. providing a conduit of connectivity for the staging, presenting, and use of human aptitude, skill, and performance by translating human activity scores into said pen ink and paper game, video game, and simulation environment gaming and simulation objects respectively, and
b. providing a means of creating, unlocking, and or enhancing gaming and simulation objects and their attributes with the translated human activity scores, and
c. providing game and simulation developers the means to create pen ink and paper game, video game, and simulation environments that compel humans to participate in activities which are exogenous to the pen ink and paper game, video game, and simulation environments they create
whereby humans can participate in end game content and simulation exercises, have quality experiences, and seamless fun and excitement in games and realistic, meaningful and relative to the abstraction of real life or otherwise simulations, without the presence of the activities which are participated in exogenously from said pen ink and paper game, video game, and simulation environments,
whereby the desire to enhance pen ink and paper game, video game, and simulation objects and object attributes compels humans to perform activities exogenous to the pen ink and paper game, video game, and simulations they play and participate in,
whereby humans can stage, present, display, realize, and or utilize activity achievements made exogenously to pen ink and paper game, video game, and simulation environments in the form of gaming and simulation objects and or the attributes of gaming and simulation objects,
whereby pen ink and paper game, video game, and simulation developers are free to create fantastic pen ink and paper games and create video games and create realistic simulations that compel humans to participate in real life activities, exogenous of the pen ink and paper game, video game, and simulation environments they create, without the burden of including real life activities in the pen ink and paper game, video game, and simulation environments themselves.
